(19) United States
(12) Patent Application Publication
(10) Pub. No.: US 2006/0230202 A1
(43) Pub. Date: Oct. 12, 2006

(54) Portable integrated circuit memory device for use with universal serial bus

(76) Inventor: Ju-Heon Lee, Suwon (KR)

Correspondence Address: Robert E. Bushnell, Suite 300, 1522 K Street, N.W., Washington, DC, 20005, US

(21) Appl. No.: 11/410,105

(22) Filed: Apr. 25, 2006

Related U.S. Application Data
(63) Continuation of application No. 09/685,138, filed on Oct. 11, 2000.

(30) Foreign Application Priority Data
Oct. 11, 1999 (KR) 43872/1999

(51) Int. Cl. G06F 13/38

(52) U.S. Cl. 710/62

(57) ABSTRACT

A portable memory device for use with a USB-supporting computer includes a USB connector, an integrated circuit memory for writing and reading data, and a USB interface, connected between the USB connector and the memory, for interfacing with the computer, and a housing for accommodating the memory and the USB interface. The memory device is used as a portable memory medium such as a floppy disk. The USB memory device is less dangerous of data loss caused by dusts or shock. Additionally, the USB memory device can be used as an electronic security key device of a computer or a computer-based system.

### CROSS-REFERENCE TO RELATED APPLICATIONS AND CLAIM OF PRIORITY

This application is a Continuation of Applicant's Ser. No. 09/685,138 filed in the U.S. Patent & Trademark Office on 11 Oct. 2000, and assigned to the assignee of the present invention. This application makes further reference to, incorporates the same herein, and claims all benefits accruing under 35 U.S.C. §119 from my application MEMORY STICK FOR UNIVERSAL SERIAL BUS filed with the Korean Industrial Property Office on Oct. 11, 1999 and there duly assigned Serial No. 43872/1999.

### BACKGROUND OF THE INVENTION

1. Field of the Invention

The present invention relates to an auxiliary memory device for use with a personal computer, and more particularly to a portable integrated circuit memory device capable of being used with a universal serial bus (USB).

2. Description of the Related Art

In the field of personal computers (PCs) and accessories, there has been rapid performance improvements in processors and memories. However, peripheral devices, such as keyboards, mouses, monitors, printers, speakers, microphones, and telephone/fax modems, remained largely unchanged during this period.

In an earlier PC arrangement, if peripherals must be connected to a computer, the sheer number of cables makes the connection between the computer and the peripherals complicated. Also, since such a computer is not always provided with a Plug-and-Play function, it is difficult for a PC user to connect peripheral devices to the computer. Furthermore, if an unskilled user strives to install expansion cards, he may be faced with a complex and bewildering collection of dip switches, circuit boards, jumper cables, peripheral drivers, interrupt request (IRQ) settings, DMA channels and I/O addresses that must be configured. To make matters worse, expanding PC functionality will often result in system crashes, thereby causing the economic loss and inconvenience to the user.

Universal serial bus (USB) system has been developed as one way to avoid some of the above difficulties. USB brings Plug-and-Play technology to the external input and output devices found on today's high-performance PCs or workstations. USB has three major advanced features as follows: (1) ease of use through hot plugging and automatic configuration, (2) standardized connection points and simplified connector design, and (3) simple expansion through the use of a tiered-star hub topology.

With USB, PC users no longer need to worry about selecting the right serial port, installing expansion cards, or the technical headaches of dip switches, jumpers, software drivers, IRQ settings, DMA channels and I/O addresses. USB allows simultaneously attaching and using of multiple devices on the same bus. USB also allows these devices to be attached and removed while a computer system is running and without requiring a reboot to use a newly attached device.

Unlike conventional PCMCIA (personal computer card international association) cards or other add-on cards, since USB does not require the investment in expansion cards, the net cost of implementing new peripheral products can be substantially lower. Also, the universal compatibility of USB eliminates much of the cost of testing and validation of varying PC-peripheral-software combinations, while accelerating time-to-market. Thus, USB will clearly continue to be used as a computer peripheral interface for the time being, along with other advanced general-purpose buses such as FW (Fire Wire; sometimes called IEEE1394) bus and SSA (Serial Storage Architecture) bus.

What is needed is a portable memory device having a USB interface that can be attached to a USB port on a host computer, allowing a user of the host computer to read and write to the portable memory device. What is also needed is a portable security device that attaches to a USB port of a host computer that allows the user to gain access to the host computer.

### SUMMARY OF THE INVENTION

It is an object of the present invention is to provide an integrated circuit memory device capable of being used with a USB-supporting computer.

It is another object of the present invention to provide an integrated circuit memory device that can be used as a portable memory medium such as a floppy disk.

It is still another object of the present invention to provide a portable memory medium having strong immunity to dusts and shocks and having a high data retention reliability.

It is still another object of the present invention to provide an electronic security key device for use in a USB-supporting computer or computer-based system.

It is yet another object of the present invention to provide a portable memory that attaches to a USB port of a host computer, allowing a user to read and write to and from the portable memory.

It is still yet another object of the present invention to provide a security device that attaches to a USB port of a host computer to enable the hard disk drive of the host computer.

According to one aspect of the present invention, there is provided a portable memory device that includes a connector having a plurality of electrical connections adapted to mate with a host device, a memory adapted to read data therefrom and store data therein, a housing adapted to enclose at least said memory, a cover adapted to cover at least a portion of said connector and an interface adapted to convey electrical signals between said memory and said connector, wherein said cover and said housing comprise cooperating guides adapted for mutual engagement.

The guides of said cover can have a convex shape. The guides of said housing can have a concave shape. The connector can be a Universal Serial Bus (USB) type connector. The cover can include a first opening adapted to accept said connector, said first opening being arranged on a first side of said cover and a second opening arranged on a second and opposite side of said cover. The cover can be adapted to move with respect to said housing in both a first direction and a second direction that is opposite to said first direction. The cover can be adapted to move in said first direction when said portable memory device is mated with said host device. The portable memory device can further include a spring adapted to cause said cover to move in said second direction when said portable memory device is removed from said host device. The power to said portable memory device can be provided by said host device. The portable memory device can be a plug-n-play type device. The portable memory device can be a security device. The portable memory device can be adapted to prevent unauthorized users from accessing information from said host device. The memory can be a nonvolatile integrated circuit memory. The nonvolatile integrated circuit memory can be a flash memory.

According to another aspect of the present invention, there is provided a portable memory device that includes a connector having a plurality of electrical connections adapted to mate with a host device, said connector also having a plurality of pin arrangements that conform to at least one USB type portable device, a memory adapted to read data therefrom and store data therein, a housing adapted to enclose at least said memory, a cover adapted to cover at least a portion of said connector and an interface adapted to convey electrical signals between said memory and said connector, wherein said portable memory device is a plug-n-play type device, said portable memory device being adapted to store security information therein that prevents unauthorized users from accessing information from said host.

According to yet another aspect of the present invention, there is provided a portable memory device that includes a connector having a plurality of electrical connections adapted to mate with a host device, a memory adapted to read data therefrom and store data therein, a housing adapted to enclose at least said memory, a cover adapted to cover at least a portion of said connector and an interface adapted to convey electrical signals between said memory and said connector, wherein said cover includes a first opening adapted to accept said connector, said first opening being arranged on a first side of said cover, said cover further includes a second opening arranged on a second and opposite side of said cover.

The connector can be a Universal Serial Bus (USB) type connector. The portable memory device can be a plug-n-play type device. The cover can be adapted to move with respect to said housing in both a first direction and a second direction that is opposite to said first direction. The cover can be adapted to move in said first direction when said portable memory device is mated with said host device. The portable memory device can further include a spring adapted to cause said cover to move in said second direction when said portable memory device is removed from said host device. The power to said portable memory device can be provided by said host device. The portable memory device can be a plug-n-play type device. The portable memory device can be a security device. The portable memory device can be adapted to prevent unauthorized users from accessing information from said host device. The memory can be a nonvolatile integrated circuit memory. The nonvolatile integrated circuit memory can be a flash memory.

### BRIEF DESCRIPTION OF THE DRAWINGS

A more complete appreciation of the invention, and many of the attendant advantages, thereof, will be readily apparent as the same becomes better understood by reference to the following detailed description when considered in conjunction with the accompanying drawings in which like reference symbols indicate the same or similar components, wherein:

FIG. 1A is a perspective view of a portable memory device according to the present invention;

FIG. 1B is a perspective view illustrating a use of the hole of the memory device of FIG. 1A.

FIGS. 2A-2C are views showing connector covers of portable memory devices according to the present invention;

FIG. 3 shows a connection between a USB memory device according to the present invention and a USB-supporting computer;

FIGS. 4A-4B are views for explaining the movement of the connector cover of FIG. 3 when the memory device is connected with the computer according to an embodiment of the present invention;

FIG. 5 is a block diagram showing a circuit configuration of a USB memory device according to the present invention;

FIG. 6 is a flowchart showing operation steps of a computer system when a USB memory device is used as a portable memory medium in the computer system according to an embodiment of the present invention; and

FIG. 7 is a flowchart showing operation steps of a computer system when a USB memory device is used as a security key device in the computer system according to an embodiment of the present invention.

### DESCRIPTION OF THE PREFERRED EMBODIMENT

Now, the present invention will be described hereinafter more fully with reference to accompanying drawings. If plugged in one of plural USB ports mounted upon a computer system irrespective of kinds of the computer system or its port, a USB memory device is directly recognized in the computer system to conveniently write/read data. The USB memory device is less prone to data loss caused by dusts or shock. Moreover, a small-sized USB memory device results in its portability.

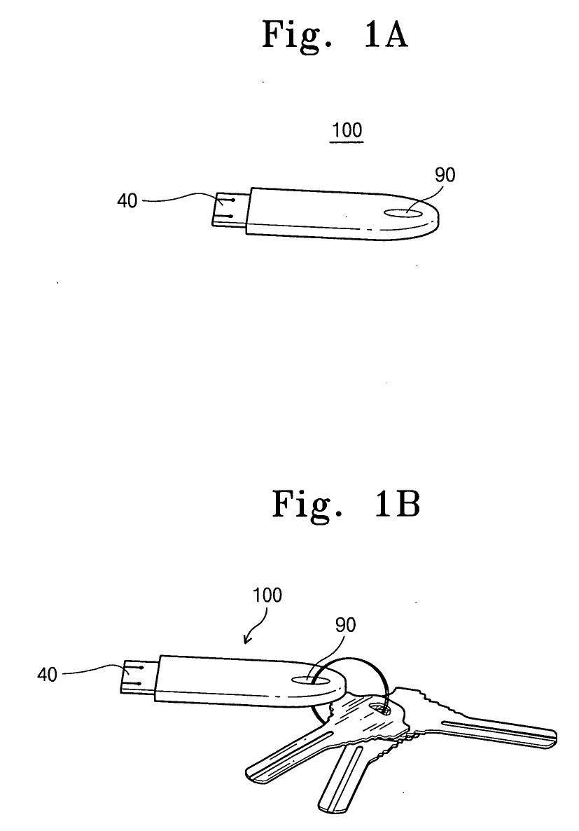

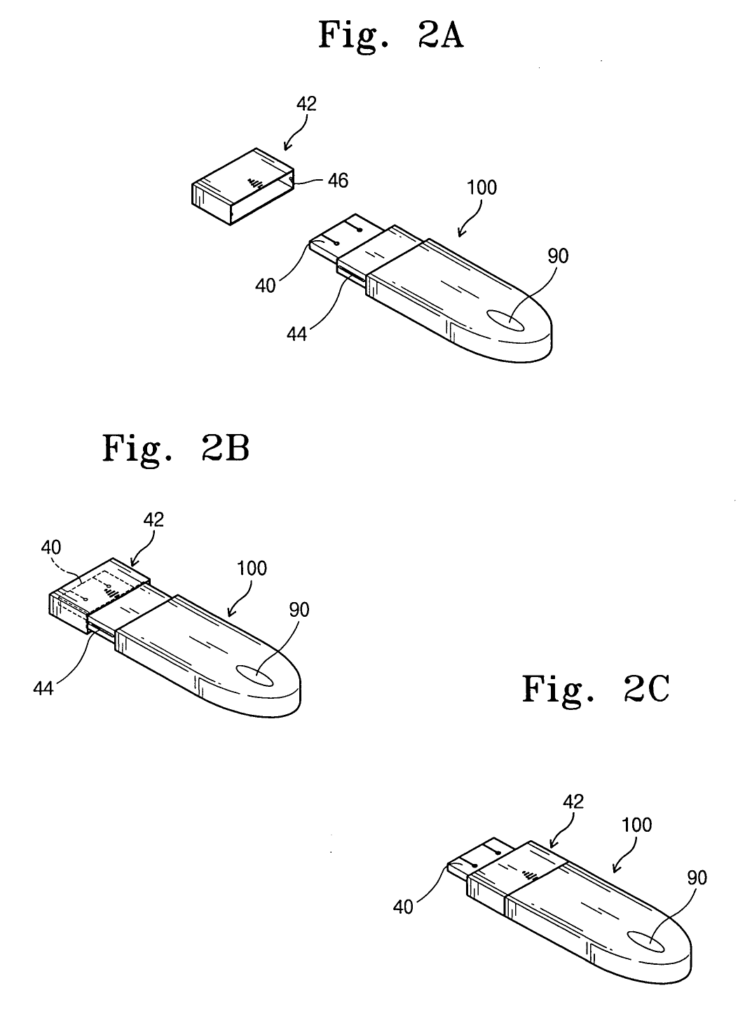

FIG. 1A is a perspective view of a portable memory device 100 according to the present invention, and FIG. 1B is a perspective view illustrating a use of the hole 90 of the memory device 100 of FIG. 1A. Referring now to FIG. 1A, the portable memory device 100 with a USB connector 40 is an external integrated circuit memory device being capable of substituting a floppy disk drive of a data processing system such as a USB-supporting computer. The memory device 100 can be used as a sub-memory of data processing systems to accommodate peripherals such as a digital camera, a digital video camera, electronic calculator, and so on. The memory device 100 can be shaped like a bar or stick.

Referring to FIG. 1B, the memory device 100 is portable owing to its small size. The memory device 100 comprises a nonvolatile integrated circuit memory and a USB interface within a housing. The housing prevents data loss caused by dust or shock in the memory device 100. The memory device 100 has a USB connector 40 on its one end and a hole 90 on the other end. The hole 90 can be used for holding a key ring. On the USB connector 40, a connector cover is coupled for protecting the USB connector.

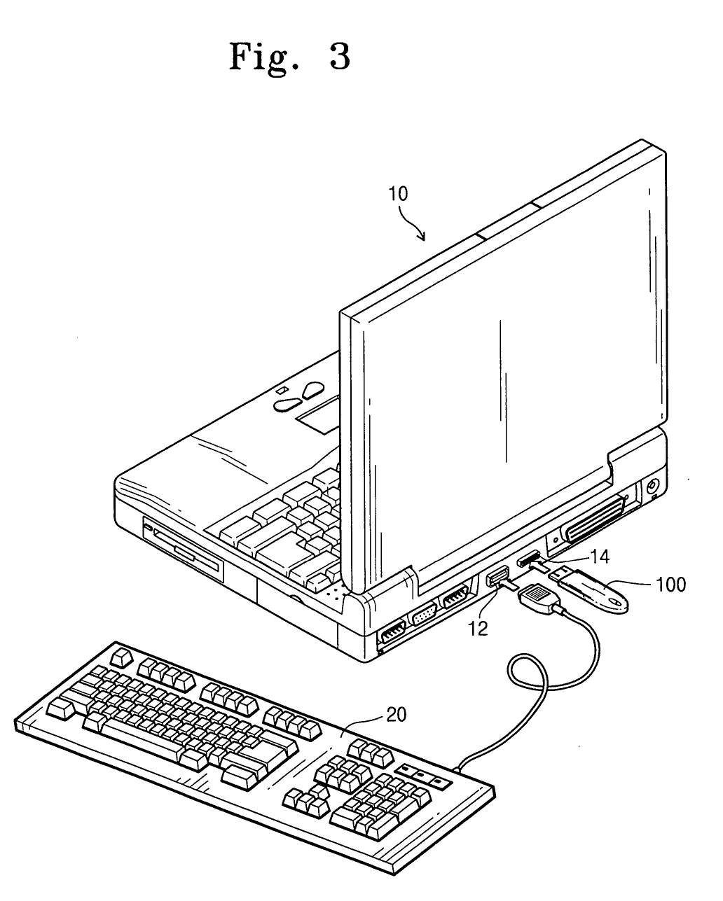

FIGS. 2A-2C show structures of a connector cover 42 and a housing of the USB memory device 100 shown in FIGS. 1A-1B to illustrate insertion and movement of the connector cover 42. In case that the USB connector 40 is uncovered with the connector cover 42, it is likely to be damaged when a user carries the memory device 100. Therefore, the memory device 100 according to the present invention has the connector cover 42 for protecting the USB connector 40 from damage.

Referring now to FIG. 2A, a housing of the USB memory device I 00 comprises one or two concave parts 44 on one or two sides of the housing, and the connector cover 42 comprises one or two convex parts 46 on one or two sides of the connector cover 42. The concave part 44 mates with the convex part 46 and are used for inserting the connector cover 42 into the housing of the USB memory device 100.

Referring now to FIG. 2B, the USB connector cover 42 is inserted to the housing of the USB memory device 100. The connector cover 42 covering the USB connector 40 is capable of moving back and forth along the concave part 44 of the housing.

Referring to FIG. 2C, the USB connector cover 42 moves backward toward hole 90 and away from the USB connector 40 along the concave part 44. For example, if the USB memory device 100 is connected to external devices through the USB connector 40, the cover 42 moves backwards from the USB connector 40 along the concave part 44 of the housing of the USB memory device 100 shown in FIG. 2A or FIG. 2B.

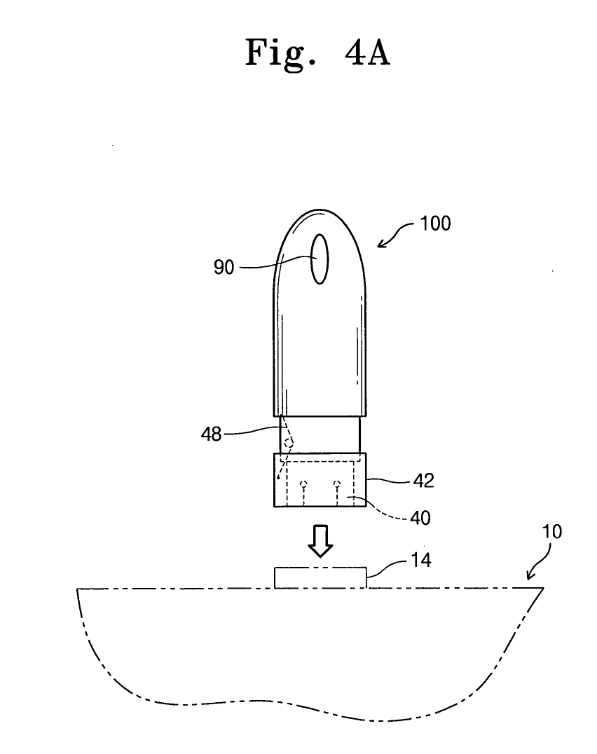

FIG. 3 is a perspective view illustrating a connection between a USB memory device 100 and a USB-supporting computer 10. Referring to FIG. 3, peripheral devices 20 and 100 connected to the USB-supporting computer 10 are powered by the computer 10 without additional power supply device. Since all of the USB devices use USB standard ports, USB devices based on a USB standard can be used in the computer 10 without considering order or location of the USB ports. In addition, the USB devices support a Plug-and-Play function in the computer 10. The USB device can be recognized automatically in the computer 10 or an operation system, without resetting the computer 10. If a USB memory device 100 is connected to one of USB ports 12 and 14 of the computer 10, the memory device 100 is directly recognized as an integrated memory device such as a floppy disk by the Plug-and-Play function. The USB memory device 100 can be used more efficiently in a portable computer having no floppy disk drive.

In addition, the USB memory device 100 can contain security information to perform security function in the computer, such as a hardware key to prevent data access of an unauthorized user. This security function of the USB memory device 100 will be described in detail later.

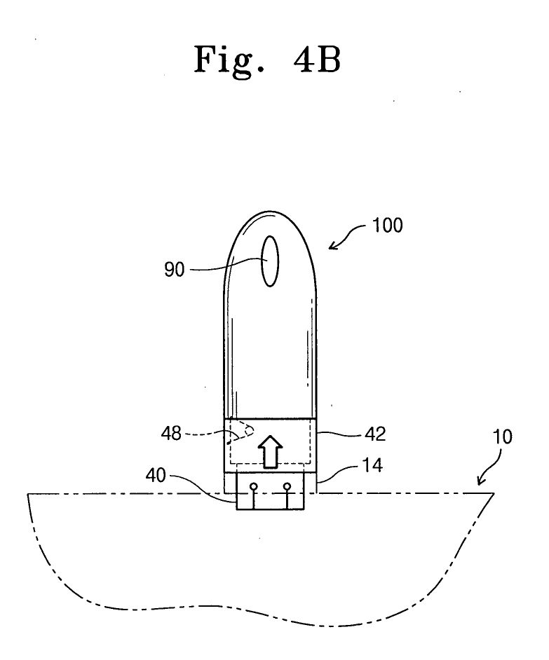

FIGS. 4A-4B are views illustrating movement of the connector cover 42 of the USB memory device 100 of FIGS. 2A-2C when the USB memory device 100 is coupled to a portable computer system 10. Referring now to FIG. 4A, a spring 48 is coupled between the concave part 44 of the housing and the connector cover 42 to control movement of the cover 42. When the USB memory device 100 is not connected to any device, the spring 48 is stretched, as shown in FIG. 4A. If the USB memory device 100 is connected to a USB port 14 of the portable computer 10, the cover 42 is pushed along an arrow and the spring 48 is compressed as shown in FIG. 4B. While the USB connector 40 and the USB port 14 are connected to each other, the spring 48 remains compressed. If the USB connector 40 and the USB port 14 are separated from each other, the spring 48 is decompressed, as shown in FIG. 4A, to make the connector cover 42 cover the USB connector 40.

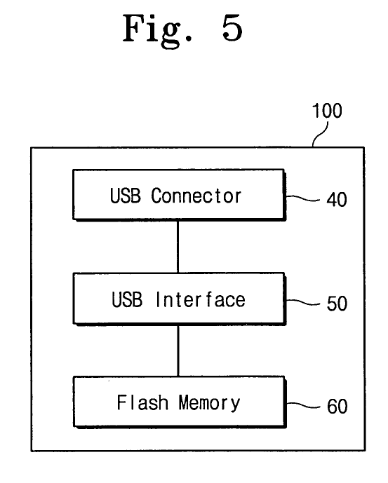

FIG. 5 schematically illustrates architecture of a USB memory device 100. Referring to FIG. 5, a USB memory device 100 comprises a USB connector 40 connected to a USB port of a data processing system, a nonvolatile integrated circuit memory 60 for writing/reading data to/from the data processing system, and a USB interface 50 connected between the USB connector 40 and the memory 60, for carrying out interface between the data processing system and the memory 60. The memory is composed of a flash memory, such as a flash EEPROM (electrically erasable and programmable read only memory), and so on.

As mentioned above, the USB memory device 100 is recognized as an integrated memory device writing/reading data such as a floppy disk by the Plug-and-Play function. Moreover, the USB memory device 100 can store security and privacy information (e.g., identification number, passport number, etc.) to recognize a user by organizing database of the information. The security information functions as a password, so that the security information is used for verifying an authorized user. Thus, the USB memory device 100 storing the security information can be used as a hardware key to permit that only authorized user access to data stored in a hard disk.

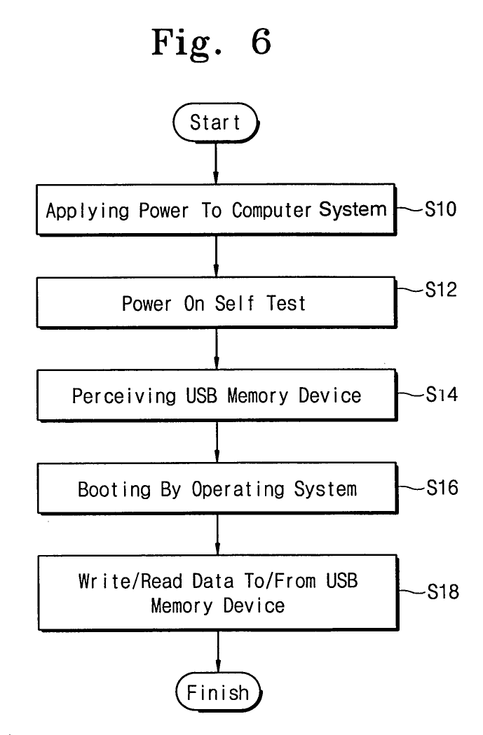

FIG. 6 is a flowchart showing operation steps of a computer system when a USB memory device is used as a portable memory medium such as a floppy disk. Referring now to FIG. 6, at step S10, power is applied to the computer system. At step S12, power on self test (POST) is carried out. In step S14, the USB memory device is recognized by the computer system. In step S16, booting is performed by an operation system (OS). In step S18, data is written/read out to/from the USB memory device.

The operation steps shown in FIG. 6 are described, when the power is applied to the computer system after plugging the USB memory device in the computer system. If the USB memory device is plugged in the computer system while applying the power to the computer system, the memory device is automatically recognized by the Plug-and-Play function.

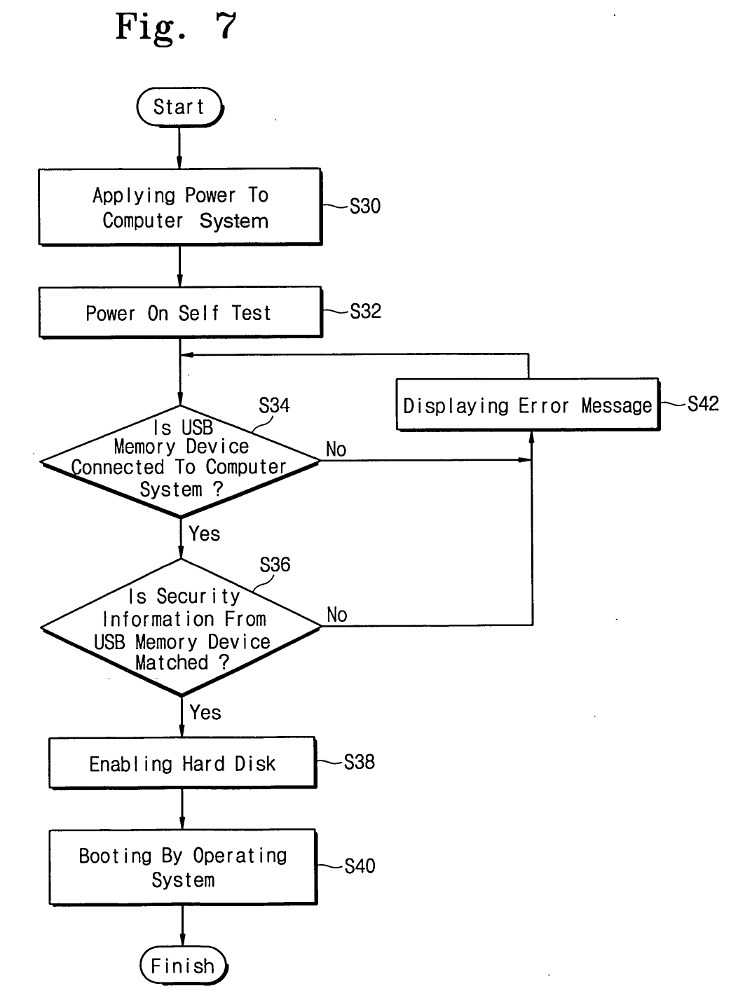

FIG. 7 illustrates operation steps of a computer system when a USB memory device is used as security key device such as a hardware key. Referring now to FIG. 7, in step S30, power is applied to the computer system. In step S32, power on self test (POST) is carried out. In step S34, it is determined whether the USB memory device is connected to the computer system. If not connected, the control flow proceeds to step S42 wherein an error message is displayed to insert a USB memory device into the computer system. If connected, the control flow proceeds to next query step S36. At step S36, it is determined whether a security information stored in the USB memory device is matched to a security information stored in the computer system by a microcontroller (not shown) of the computer system. The microcontroller contains a program for comparing the security information from the USB memory device with the security information of the computer system, and verifies an authorized user by the comparing result. If the security information is not correct, the control flow continues to step S42 wherein an error message is displayed to insert a right USB memory device storing reasonable security information into the computer system, and then the flow returns to step S34. If the security information from the USB memory device is matched with the security information of the computer system, the control flow continues to step S38 wherein a hard disk is enabled. In step S40, booting is performed by an operating system (OS). According to the above described operating steps, the USB memory device can be used as a security key device including a security information to control data access of the hard disk.

As a result, the USB memory device according to the present invention can write/read data as an integrated memory circuit after connecting to the USB-supporting computer system irrespective of kinds of the computer system and its ports. In addition, the USB memory device can be used as a security key device storing a security information. Further, the USB memory device is less dangerous of data loss, and is more portable owing to its small size.

What is claimed is:

1-20. (canceled)

21. A portable memory device, comprising:
a connector having a plurality of electrical connections adapted to mate with a host device;
a memory adapted to read data therefrom and/or store data therein;
a housing adapted to enclose at least said memory;
a cover adapted to cover at least a portion of said connector; and
an interface adapted to convey electrical signals between said memory and said connector,
wherein said cover and said housing comprise cooperating guides adapted for mutual engagement.

22. The portable memory device of claim 21, wherein the guides of said cover have a convex shape.

23. The portable memory device of claim 22, wherein the guides of said housing have a concave shape.

24. The portable memory device of claim 21, wherein said connector is a Universal Serial Bus (USB) type connector.

25. The portable memory device of claim 21, wherein said cover comprises:
a first opening adapted to accept said connector, said first opening being arranged on a first side of said cover; and
a second opening arranged on a second and opposite side of said cover.

26. The portable memory device of claim 21, wherein said cover is adapted to move with respect to said housing in both a first direction and a second direction that is opposite to said first direction.

27. The portable memory device of claim 26, wherein said cover is adapted to move in said first direction when said portable memory device is mated with said host device.

28. The portable memory device of claim 27, further comprising a spring adapted to cause said cover to move in said second direction when said portable memory device is removed from said host device.

29. The portable memory device of claim 21, wherein power to said portable memory device is provided by said host device.

30. The portable memory device of claim 21, wherein said portable memory device is a plug-n-play type device.

31. The portable memory device of claim 21, wherein said portable memory device is a security device.

32. The portable memory device of claim 31, wherein said portable memory device is adapted to prevent unauthorized users from accessing information from said host device.

33. The portable memory device of claim 31, wherein said memory is a nonvolatile integrated circuit memory.

34. The portable memory device of claim 33, wherein said nonvolatile integrated circuit memory is a flash memory.

35. A USB type portable memory device, comprising:
a connector having a plurality of electrical connections adapted to mate with a host device, said connector also having a plurality of pin arrangements that conform to at least one USB type portable device;
a memory adapted to read data therefrom and/or store data therein;
a housing adapted to enclose at least said memory;
a cover adapted to cover at least a portion of said connector; and
an interface adapted to convey electrical signals between said memory and said connector, wherein said portable memory device is a plug-n-play type device, said portable memory device being adapted to store security information therein that prevents unauthorized users from accessing information from said host.

36. A portable memory device, comprising:
a connector having a plurality of electrical connections adapted to mate with a host device;
a memory adapted to read data therefrom and/or store data therein;
a housing adapted to enclose at least said memory;
a cover adapted to cover at least a portion of said connector; and
an interface adapted to convey electrical signals between said memory and said connector, wherein said cover includes a first opening adapted to accept said connector, said first opening being arranged on a first side of said cover, said cover further includes a second opening arranged on a second and opposite side of said cover.

37. The portable memory device of claim 36, wherein said connector is a Universal Serial Bus (USB) type.

38. The portable memory device of claim 36, wherein said portable memory device is a plug-n-play type device.

39. The portable memory device of claim 36, wherein said cover is adapted to move with respect to said housing in both a first direction and a second direction that is opposite to said first direction.

40. The portable memory device of claim 39, wherein said cover is adapted to move in said first direction when said portable memory device is mated with said host device.

41. The portable memory device of claim 40, further comprising a spring adapted to cause said cover to move in said second direction when said portable memory device is removed from said host device.

42. The portable memory device of claim 36, wherein the power to said portable memory device is provided by said host.

43. The portable memory device of claim 36, wherein said portable memory device is a security device.

44. The portable memory device of claim 43, wherein said portable memory is adapted to prevent unauthorized users from accessing information from said host.

45. The portable memory device of claim 36, wherein said memory is a nonvolatile integrated circuit memory.

46. The portable memory device of claim 45, wherein said nonvolatile integrated circuit memory is a flash memory.
